(19) United States
(12) Patent Application Publication
(10) Pub. No.: US 2008/0164800 A1
(43) Pub. Date: Jul. 10, 2008

(54) SPARK PLUG ENSURING ENHANCED IGNITABILITY OF FUEL

(75) Inventor: Tetsuya WATANABE, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/947,940

(22) Filed: Nov. 30, 2007

(30) Foreign Application Priority Data
Jan. 10, 2007 (JP) 2007-002691

(51) Int. Cl. H01T 13/20; H01T 13/46

(52) U.S. Cl. 313/141

(57) ABSTRACT

A spark plug for an internal combustion engine equipped with a main and an auxiliary ground electrode. The auxiliary ground electrode has an inner end which faces a spark gap and includes a top edge and a base edge located outward and inward, as viewed in a longitudinal direction of the spark plug. The top edge is located closer to the top of the spark plug than a center electrode-facing surface of the main ground electrode or flush with the center electrode-facing surface. The distance A between the base edge and the center electrode-facing surface and the distance Gm of the spark gap are selected to meet a relation of A≧Gm/3. This serves to block the entrance of a fast stream of air-fuel mixture such as the swirl, as created within a combustion chamber, into the spark gap, thereby ensuring the stability in igniting the mixture.

### CROSS REFERENCE TO RELATED DOCUMENT

The present application claims the benefits of Japanese Patent Application No. 2007-2691 filed on Jan. 10, 2007, the disclosure of which is totally incorporated herein by reference.

### BACKGROUND OF THE INVENTION

1. Technical Field of the Invention

The present invention relates generally to a spark plug for an internal combustion engine which may be employed in automotive vehicles, and more particularly to such a spark plug designed to ensure enhanced ability in igniting fuel.

2. Background Art

There are typical spark plugs equipped with a metal shell with an external plug-installation thread, a porcelain insulator retained in the metal shell, a center electrode installed in the porcelain insulator, and a ground electrode joined to the metal shell to define a spark gap between itself and the center electrode.

In such a type of spark plug, electrons, as emitted from the center electrode, reach the ground electrode, thereby developing an electrically brokendown path through which an induced discharge current flows. This creates a spark in the spark gap to ignite an air-fuel mixture within a combustion chamber of the engine to create a flame. The flame then grows to complete the combustion of the mixture.

In order to improve the efficiency in the combustion of the mixture, the swirl (a flow of an air-fuel mixture produced in an intake stroke which is oriented perpendicular to the length of the spark plug within the combustion chamber) or the tumble flow (i.e., a flow of the air-fuel mixture over a plane extending along the length of the spark plug within the combustion chamber) may be developed. However, when such flows of the air-fuel mixture pass through the spark gap of the spark plug strongly, it may result in a drift of a spark from the spark gap, thus leading to a misfire of the mixture. Particularly, a strong flow of the mixture on the top end of the center electrode from which the spark is emitted or on the surface of the ground electrode facing the center electrode often results in the misfire of the mixture.

In recent years, spark plugs equipped with a center electrode whose top end is as thinner as 0.4 mm have been developed in order to improve the ignitability of the air-fuel mixture. Use of such a type of center electrode, however, results in an increased possibility of the misfire.

In order to avoid the above problem, Japanese Patent First Publication No. 2003-317897 teaches use of a shield wall which is installed on a side of the spark gap to block the flow of the air-fuel mixture into the spark gap. This structure, however, has the drawback in that the shield wall undesirably blocks the spread of a flame, as created in the spark gap, over the whole the combustion chamber, which may result in a failure in igniting the mixture.

Japanese Patent First Publication Nos. 2003-257585, 5-326107, and 8-315955 teach spark plugs equipped with a main ground electrode and a second ground electrode installed to face a side wall of the center electrode. The spark plugs are, however, not designed to block the flow of the mixture into the spark gap to solve the above problems.

### SUMMARY OF THE INVENTION

It is therefore a principal object of the invention to avoid the disadvantages of the prior art.

It is another object of the invention to provide an improved structure of a spark plug for internal combustion engines which is designed to have an enhanced ability to ignite a fuel gas.

According to one aspect of the invention, there is provided a spark plug for an internal combustion engine which has a length with a top and a base. The spark plug comprises: (a) a metal shell; (b) a porcelain insulator retained in the metal shell; (c) a center electrode installed in the porcelain insulator; (d) a main ground electrode including an upright portion and a center electrode-facing portion, the upright portion extending from the metal shell in a longitudinal direction of the spark plug, the center electrode-facing portion extending from the upright portion inwardly of the spark plug in a lateral direction substantially perpendicular to the longitudinal direction to have a center electrode-facing surface facing the center electrode to define a spark gap between itself and a top end of the center electrode; and (d) an auxiliary ground electrode including an upright portion and an inward-facing portion. The upright portion extends from the metal shell in the longitudinal direction of the spark plug. The inward-facing portion extends from the upright portion inwardly of the spark plug in the lateral direction to have an inner end facing the spark gap. The inner end of the inward-facing portion has a top edge and a base edge located outward and inward, respectively, as viewed in the longitudinal direction of the spark plug. The top edge is located closer to the top of the spark plug than the center electrode-facing surface of the main ground electrode or flush with the center electrode-facing surface. A distance A between the base edge of the inner end of the inward-facing portion of the auxiliary ground electrode and the center electrode-facing surface of the main ground electrode, as defined in the longitudinal direction of the spark plug, and a distance Gm of the spark gap, as defined in the longitudinal direction of the spark plug, are selected to meet a relation of A≧Gm/3.

Specifically, the inner end of the inward-facing portion of the auxiliary ground electrode is, as described above, geometrically oriented relative to a portion of the main ground electrode near the spark gap so as to meet the relation of A≧Gm/3. This blocks or avoids entrance of a fast stream of air-fuel mixture such as the swirl, as created within a combustion chamber of the engine, into the spark gap near the main ground electrode. More specifically, the inner end of the inward-facing portion is so located as to satisfy the above condition, which results in the creation of a turbulent flow of the mixture around the center electrode-facing surface of the main ground electrode within the spark gap to minimize the creation of a flow of the mixture passing near the center electrode-facing surface of the main ground electrode at high speeds, thereby avoiding the leaving of sparks, as produced in the spark gap, from the main ground electrode to ensure the stability in igniting the mixture within the combustion chamber.

In the preferred mode of the invention, the base edge of the inner end of the inward-facing portion of the auxiliary ground electrode is located one of flush with the top end of the center electrode and closer to the base of the spark plug than the top end of the center electrode. A distance B between the top edge of the inner end of the inward-facing portion of the auxiliary ground electrode and the top end of the center electrode, as defined in the longitudinal direction of the spark plug, is selected to meet a relation of B≧Gm/3.

A minimum distance Gs (mm) between the auxiliary ground electrode and the center electrode is selected to meet a relation of Gs≧Gm+0.4 mm where a unit of Cm is mm.

A minimum distance C (mm) between the main ground electrode and the auxiliary ground electrode, as defined on a plane extending in the lateral direction of the spark plug and a minimum distance Gs (mm) between the auxiliary ground electrode and the center electrode are selected to meet a relation of 0.2 mm≦C≦Gs+0.2 mm.

The inward-facing portion of the auxiliary ground electrode is smaller in thickness and width than the center electrode-facing portion of the main ground electrode.

The center electrode is made up of a top portion and a body portion, the top portion being smaller in diameter than the body portion.

According to the second aspect of the invention, there is provided a spark plug for an internal combustion engine which has a length with a top and a base. The spark plug comprises: (a) a metal shell; (b) a porcelain insulator retained in the metal shell; (c) a center electrode installed in the porcelain insulator; (d) a main ground electrode including an upright portion and a center electrode-facing portion, the upright portion extending from the metal shell in a longitudinal direction of the spark plug, the center electrode-facing portion extending from the upright portion inwardly of the spark plug in a lateral direction substantially perpendicular to the longitudinal direction to have a center electrode-facing surface facing the center electrode to define a spark gap between itself and a top end of the center electrode; and (e) an auxiliary ground electrode including an upright portion and an inward-facing portion. The upright portion extends from the metal shell in the longitudinal direction of the spark plug. The inward-facing portion extends from the upright portion inwardly of the spark plug in the lateral direction to have an inner end facing the spark gap. The base edge of the inner end of the inward-facing portion of the auxiliary ground electrode is located flush with the top end of the center electrode or closer to the base of the spark plug than the top end of the center electrode. A distance B between the top edge of the inner end of the inward-facing portion of the auxiliary ground electrode and the top end of the center electrode, as defined in the longitudinal direction of the spark plug, is selected to meet a relation of B≧Gm/3.

Specifically, the inner end of the auxiliary ground electrode is so located relative to the spark gap near the center electrode as to meet the above condition, thereby blocking or avoiding the entrance of a fast stream of air-fuel mixture such as the swirl, as created within a combustion chamber of the engine, into the spark gap near the center electrode. More specifically, the inner end of the inward-facing portion of the auxiliary ground electrode is so located as to satisfy the above condition, which results in the creation of a turbulent flow of the mixture around the top end of the center electrode within the spark gap to minimize the creation of a flow of the mixture passing near the top end of the center electrode 3 (i.e., the point at which the sparks occur). This avoids a drift of the sparks, as produced in the spark gap, from the center electrode to ensure the stability in igniting the mixture within the combustion chamber.

In the preferred mode of the invention, a minimum distance Gs (mm) between the auxiliary ground electrode and the center electrode is selected to meet a relation of Gs≧Gm+0.4 mm where a unit of Gm is mm.

A minimum distance C (mm) between the main ground electrode and the auxiliary ground electrode, as defined on a plane extending in the lateral direction of the spark plug and a minimum distance Gs (mm) between the auxiliary ground electrode and the center electrode are selected to meet a relation of 0.2 mm≦C≦Gs+0.2 mm.

The inward-facing portion of the auxiliary ground electrode is smaller in thickness and width than the center electrode-facing portion of the main ground electrode.

The center electrode is made up of a top portion and a body portion, the top portion being smaller in diameter than the body portion.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partial side view which shows a top portion of a spark plug according to the first embodiment of the invention;

FIG. 2 is a partially longitudinal sectional view which shows a spark plug according to the first embodiment of the invention;

FIG. 3 is a top view which shows the layout of ground electrodes of the spark plug of FIG. 2;

FIG. 4(a) is a partially side view which shows an end of a main ground electrode of the spark plug of FIG. 2;

FIG. 4(b) is a partially side view which shows an end of an auxiliary ground electrode of the spark plug of FIG. 2;

FIG. 5 is a partial side view which shows a top portion of a spark plug according to the second embodiment of the invention;

FIG. 6 is a partial side view which shows a top portion of a spark plug according to the third embodiment of the invention;

FIGS. 7(a) to 7(d) are top views which illustrate modifications of the layout of main and auxiliary ground electrodes of a spark plug according to the fourth embodiment of the invention;

FIG. 8 is a partial side view which shows a spark plug test sample, as used to evaluate the ability of spark plugs of the invention to ignite an air-fuel mixture;

FIGS. 9(a) to 9(f) are side views which show variations in layout of a main ground electrode or auxiliary ground electrodes of spark plug test samples;

FIG. 10 is a graph which represents experimental results of measurements of concentration of unburned gas using the spark plug test samples of FIGS. 9(a) to 9(f);

FIG. 11 is a graph which represents output torques produced by an internal combustion engine in which spark plug test samples having a spark gap of 0.4 mm are installed; and

FIG. 12 is a graph which represents output torques produced by an internal combustion engine in which spark plug test samples having a spark gap of 1 mm are installed.

### DESCRIPTION OF THE PREFERRED EMBODIMENTS

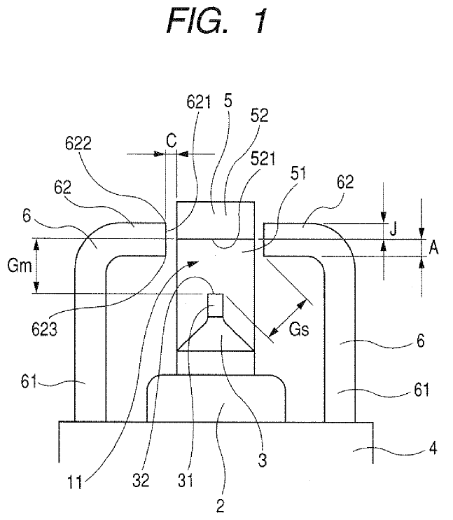

Referring to the drawings, wherein like reference numbers refer to like parts in several views, particularly to FIGS. 1 to 4(b), there is shown a spark plug 1 for use in internal combustion engines according to the first embodiment of the invention. The spark plug 1 is used in internal combustion engines which may be employed in automotive vehicles, cogeneration systems, or gas feed pumps.

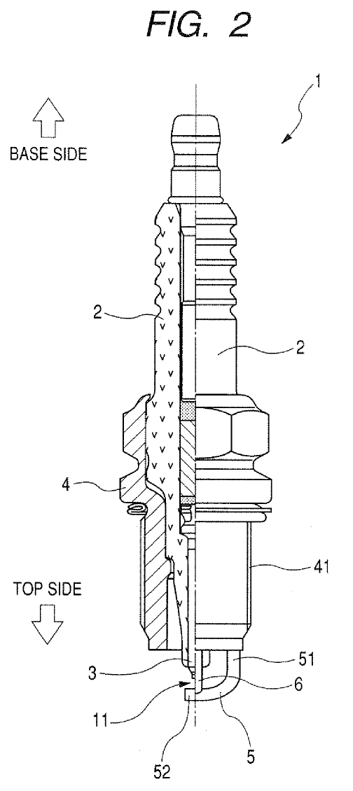

The spark plug 1, as can be seen from FIGS. 1 and 2, includes a hollow cylindrical metal shell 4, a porcelain insulator 2, a center electrode 3, a main ground electrode 5, and auxiliary ground electrodes 6. The metal shell 4 has formed on an outer periphery thereof a plug-installation thread 41 for installation of the spark plug 1 in the internal combustion engine. The porcelain insulator 2 is retained in the metal shell 4 to have a top or nose projecting therefrom. The center electrode 3 is retained in the porcelain insulator 2. The main ground electrode 5 is welded to the metal shell 4 and faces the center electrode 3 to define a spark gap 11. The auxiliary ground electrodes 6 are welded at base ends thereof to the metal shell 4.

The main ground electrode 5 is made up of an upright portion 51 and a center electrode-facing portion 52. The upright portion 51 extends vertically from the metal shell 4. The center electrode-facing portion 52 extends horizontally from a bend of the main ground electrode 5 in a radial direction of the spark plug 1 over the top end of the center electrode 3.

Each of the auxiliary ground electrodes 6 is made up of an upright portion 61 and an inward-facing portion 62. The upright portion 61 extends from the metal shell 4 vertically. The inward-facing portion 62 extends horizontally and inwardly from the upright portion 61 to have an inner end 621 facing the spark gap 11.

Each of the auxiliary ground electrodes 6 has an outside edge (i.e., a top edge) 622 that is an outside corner of the inner end 621. The outside edge 622 is located closer to the top of the spark plug 1 (i.e., the outside end of the main ground electrode 5) than a center electrode-facing surface 521 that is a lower surface of the center electrode-facing portion 52 of the main ground electrode 5. The outside edge 622 may alternatively lie flush with the center electrode-facing surface 521 on a horizontal plane extending perpendicular to the longitudinal center line of the spark plug 1.

If the distance between an inside edge (i.e., a base edge) 623 of the inner end 621 of each of the auxiliary ground electrodes 6 and the center electrode-facing surface 521 of the main ground electrode 5 in a longitudinal direction (i.e., an axial direction) of the spark plug 1 is defined as A (mm) and the size or distance of the spark gap 11 in the longitudinal direction of the spark plug 1 is defined as Gm (mm), they are selected to meet a relation of A≧Gm/3.

A minimum distance Gs (mm) between each of the auxiliary ground electrodes 6 and the center electrode 3 is selected to meet a relation of Gs≧Gm+0.4 mm.

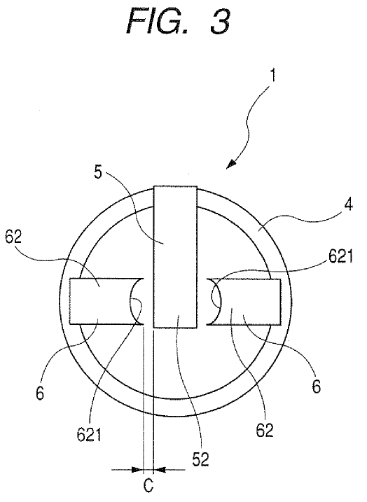

A minimum interval C, as clearly illustrated in FIGS. 1 and 3, between the main ground electrode 5 and each of the auxiliary ground electrodes 6, as defined on a plane extending perpendicular to the longitudinal center line (i.e., the length) of the spark plug 1, is selected to meet a relation of 0.2 mm≦C≦Gs+0.2 mm.

The inner end 621 of the inward-facing portion 62 of each of the auxiliary ground electrodes 6 is, as can be seen in FIG. 3, curved in an arc form, as viewed vertically of the spark plug 1.

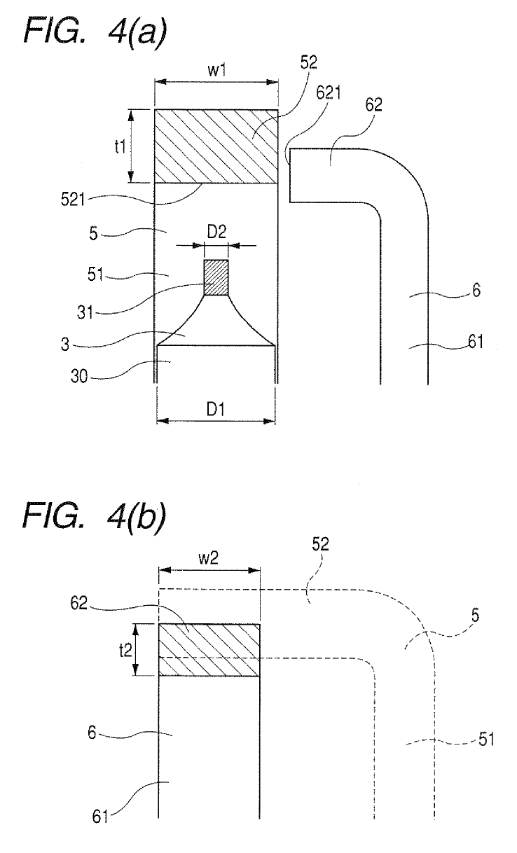

The inward-facing portion 62 of each of the auxiliary ground electrodes 6 is smaller in width and thickness than the center electrode-facing portion 52 of the main ground electrode 5. Specifically, as illustrated in FIGS. 4(a) and 4(b), the width w1 and thickness t1 of the center electrode-facing portion 52 of the main ground electrode 5 and the width w2 and thickness t2 of the inward-facing portion 62 of the auxiliary ground electrode 6 are selected to meet relations of w1≧w2 and t1≧t2.

The center electrode 3 has a thin top portion 31 which is the smallest in diameter in the whole body thereof. The diameter of the top portion 31 is preferably between 0.2 mm and 2 mm. Specifically, the center electrode 3 includes a base body 30 which is almost retained inside the porcelain insulator 2 and made of a Ni-alloy and the top portion 31 which is welded to the base body 30 and made of a noble metal such as Iridium or an alloy composed mostly of such a noble metal. The base body 30 has a diameter D1 which is smaller than a diameter D2 of the top portion 31. For example, D=2.6 mm, and D2=0.4 mm.

The main ground electrode S and the auxiliary ground electrodes 6 are each made of a Ni-alloy. The main ground electrode 5 may have a noble metal chip welded to the center electrode-facing surface 521 thereof to define the spark gap 11 between itself and the center electrode 3.

The auxiliary ground electrodes 6 are opposed diametrically to each other across the axis of the spark plug 1 and symmetrical in shape with respect to the axis of the spark plug 1. Only either one of the auxiliary ground electrodes 6 may be shaped to meet the above described dimensional conditions.

The spark plug 1 may be designed to have only one of the auxiliary ground electrodes 6 or three or more auxiliary ground electrodes 6.

The beneficial advantages of the spark plug 1 will be described below.

The inner end 621 of the inward-facing portion 62 of at least one of the auxiliary ground electrodes 6 is, as described above, geometrically oriented relative to a portion of the main ground electrode 5 near the spark gap 11 so as to meet the relation of A≧Gm/3. This blocks or avoids entrance of a fast stream of air-fuel mixture such as the swirl, as created within a combustion chamber of the engine, into the spark gap 11 near the main ground electrode 5. Specifically, the inner end 621 of the inward-facing portion 62 of the auxiliary ground electrode 6 is so located as to satisfy the above condition, which results in the creation of a turbulent flow of the mixture around the center electrode-facing surface 521 of the main ground electrode 5 within the spark gap 11 to minimize the creation of a flow of the mixture passing near the center electrode-facing surface 521 of the main ground electrode 5 at high speeds, thereby avoiding the leaving or drift of sparks, as produced in the spark gap 11, from the main ground electrode 5 to ensure the stability in igniting the mixture within the combustion chamber.

The minimum distance Gs (mm) between at least one of the auxiliary ground electrodes 6 and the center electrode 3 is, as described above, determined to meet the relation of Gs≧Gm+0.4 mm. This minimizes the creation of sparks in an air gap between the auxiliary ground electrode 6 and the center electrode 3, thereby ensuring the stability in producing a sequence of sparks within the spark gap 11 between the main ground electrode 5 and the center electrode 3.

The minimum interval C between the main ground electrode 5 and at least one of the auxiliary ground electrodes 6 is, as described above, selected to meet the relation of 0.2 mm≦C≦Gs+0.2 mm. This serves to avoid the misfiring of the spark plug 1 and facilitate spatial spread of a sequence of sparks, as produced in the spark gap 11, toward the depth of the combustion chamber of the engine, thereby enhancing the effects of the tumble flow of the mixture on the ignitability of the mixture within the combustion chamber.

The inward-facing portion 62 of at least one of the auxiliary ground electrodes 6 is smaller in both width and thickness than the center electrode-facing portion 52 of the main ground electrode 5, thereby resulting in a smaller thermal capacity of the auxiliary ground electrode 6 than that of the main ground electrode 5 which minimizes the extinguishing of flame, as produced within the spark gap 11, when touching the auxiliary ground electrode 6.

The center electrode 3 has the thin top portion 31, thereby facilitating the creation of a sequence of sparks in the spark gap 11 and resulting in a decrease in voltage required by the spark plug 1 to discharge. It also results in a decrease in thermal capacity of the center electrode 3 which minimizes the misfiring of the spark plug 1 to enhance the stability in igniting the mixture.

Usually, the provision of the thin top portion 31 may result in the misfire of the mixture arising from a drift of sparks by a stream of the mixture. The structure of the spark plug 1, as already described, works to minimize the misfiring of the spark plug 1 arising from the stream of the mixture and may, therefore, be used with the center electrode 3 with the thin top portion 31 without sacrificing the ability in igniting the mixture.

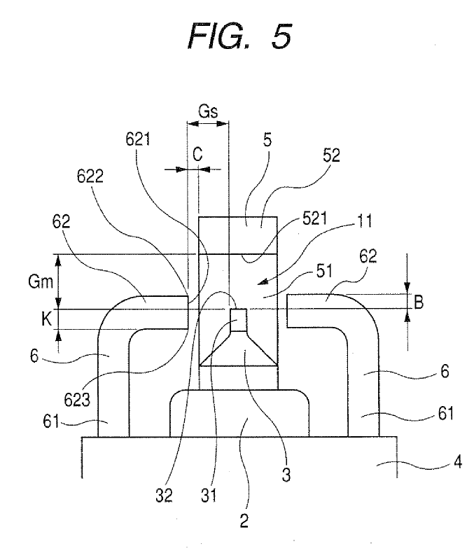

FIG. 5 illustrates the spark plug 1 according to the second embodiment of the invention which is so designed that the inner end 621 of the inward-facing portion 62 of each of the auxiliary ground electrodes 6 is oriented to face a portion of the spark gap 11 near the center electrode 3.

The inner end 621 of at least one of the auxiliary ground electrodes 6 has the inside edge 623 located inwardly of the top end 32 of the center electrode 3 in the longitudinal direction of the spark plug 1. The inside edge 632 may alternatively lie flush with the top end 32 of the center electrode 3 on a horizontal plane extending perpendicular to the longitudinal center line of the spark plug 1.

A distance B between the outside edge 622 of the inner end 621 of the inward-facing portion 62 of at least one of the auxiliary ground electrode 6 and the top end 32 of the center electrode 3, as defined in the axial direction of the spark plug 1, and the distance Gm of the spark gap 11, as defined in the axial direction of the spark plug 1, are selected to meet a relation of B≧Gm/3.

Other arrangements are identical with those in the first embodiment, and explanation thereof in detail will be omitted here.

The beneficial advantages of the spark plug 1 will be described below.

The inside edge 623 of the inner end 621 of at least one of the auxiliary ground electrodes 6 is so located relative to the spark gap 11 near the center electrode 3 as to meet the above condition, thereby blocking or avoiding the entrance of a fast stream of air-fuel mixture such as the swirl, as created within a combustion chamber of the engine, into the spark gap 11 near the center electrode 3. Specifically, the inner end 621 of the inward-facing portion 62 of the auxiliary ground electrode 6 is so located as to satisfy the above condition, which results in the creation of a turbulent flow of the mixture around the top end 32 of the center electrode 3 within the spark gap 11 to minimize the creation of a flow of the mixture passing near the top end 32 of the center electrode 3 (i.e., the point at which the sparks occur). This avoids the leaving of the sparks, as produced in the spark gap 11, from the center electrode 3 to ensure the stability in igniting the mixture within the combustion chamber.

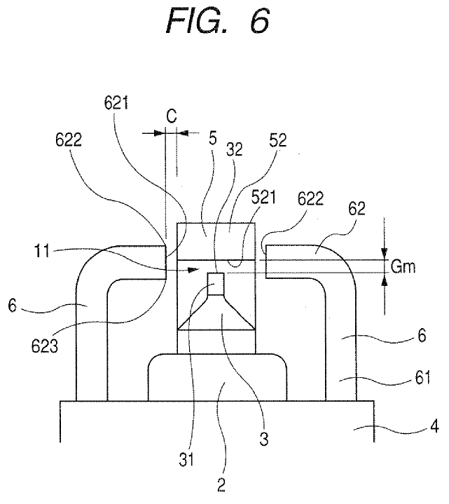

FIG. 6 illustrates the spark plug 1 according to the third embodiment of the invention.

The outside edge 622 of the inner end 621 of the inward-facing portion 62 of each of the auxiliary ground electrodes 6 is located closer to the top of the spark plug 1 (i.e., the outside end of the main ground electrode 5) than the center electrode-facing surface 521 of the main ground electrode 5. The outside edge 622 may alternatively lie flush with the center electrode-facing surface 521 on a horizontal plane extending perpendicular to the longitudinal center line of the spark plug 1. The inside edge 623 of the inner end 621 of the inward-facing portion 62 of each of the auxiliary ground electrodes 6 is located closer to the based end of the spark plug 1 (i.e., more inwardly) than the top end 32 of the center electrode 3 in the longitudinal direction of the spark plug 1. The inside edge 623 may alternatively lie flush with the top end 32 on a horizontal plane extending perpendicular to the longitudinal center line of the spark plug 1.

The length of the inner end 621 of each of the auxiliary ground electrodes 6, as defined in the longitudinal direction of the spark plug 1, that is, the thickness t2 of the inward-facing portion 62 is more than or equal to the distance Gm of the spark gap 11.

Other arrangements are identical with those in the first embodiment, and explanation thereof in detail will be omitted here.

The structure of this embodiment offers a combination of the advantages in the first and second embodiments, thus resulting in further enhanced ability of the spark plug 1 to ignite the air-fuel mixture.

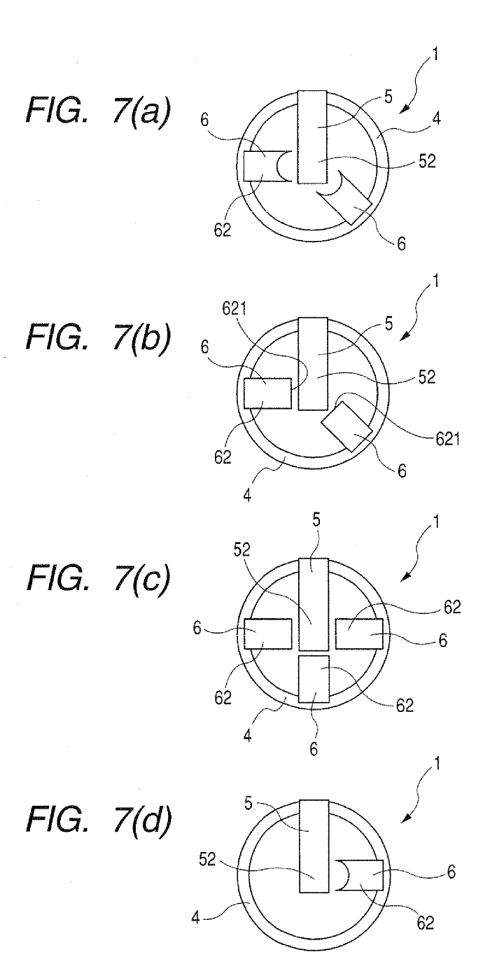

FIGS. 7(a) to 7(d) illustrates as the fourth embodiment, modifications of the shape or layout of the auxiliary ground electrodes 6, as viewed from above the top of the spark plug 1.

The structure of FIG. 7(a) is a modification of the first embodiment and has one of the auxiliary ground electrodes 6 is oriented to face the main ground electrode 5 diagonally. Specifically, the one of the auxiliary ground electrodes 6 faces one of end corners of the center electrode-facing portion 52.

The structure of FIG. 7(b) is so designed that the inner end 621 of the inward-facing portion 62 of each of the auxiliary ground electrodes 6 is shaped flat and identical with that of FIG. 7(a) in the layout of the auxiliary ground electrodes 6.

The structure of FIG. 7(c) is designed to have three auxiliary ground electrodes 6 each of which has the flat inner end 621, like in FIG. 7(b). Two of the auxiliary ground electrodes 6 are, like in the first embodiment, opposed diametrically to each other in a direction perpendicular to the center electrode-facing portion 52 of the main ground electrode 5. The remaining one of the auxiliary ground electrodes 6 is located to extend parallel to the center electrode-facing portion 52 of the main ground electrode 5. The inner end 621 of the inward-facing portion 62 of each of the auxiliary ground electrodes 6 is, like in FIG. 7(b), shaped flat.

The structure of FIG. 7(d) is designed to have the single auxiliary ground electrode 6. Other arrangements are identical with those in the first embodiment, and explanation thereof in detail will be omitted here.

The spark plug 1 may alternatively be designed to have the auxiliary ground electrode(s) 6 different in shape and layout from those in FIGS. 7(a) to 7(d).

We performed tests to evaluate the ability of the spark plug 1 to ignite the air-fuel mixture in terms of the layout of the auxiliary ground electrodes 6.

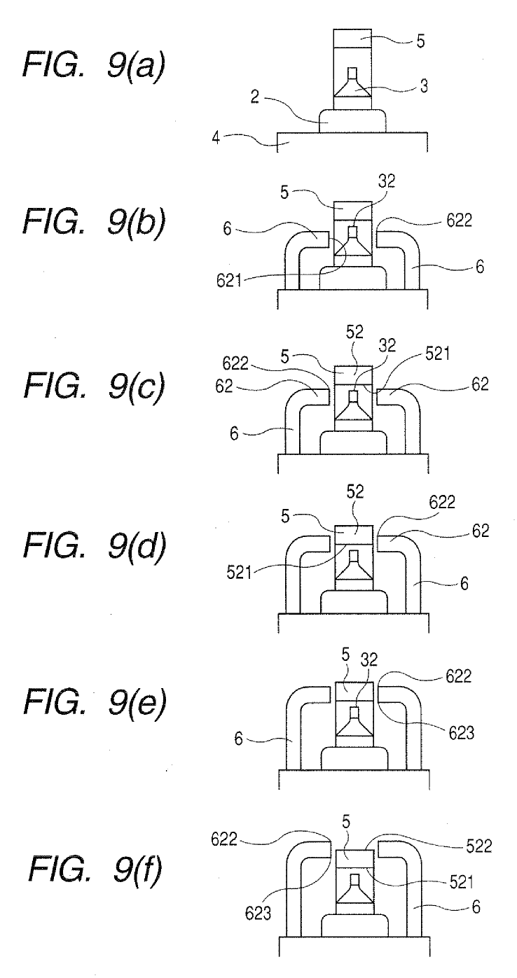

We prepared six types of plug samples which were, as illustrated in FIGS. 9(a) to 9(f), different in layout of the auxiliary ground electrode(s) 6. Each type further includes two types: one being 0.4 mm, and the other being 1 mm in the distance Gm of the spark gap 11.

FIG. 9(a) illustrates the plug samples Nos. 11 and 21 which are comparative test samples which do not have the auxiliary ground electrodes 6.

FIG. 9(b) illustrates the plug samples Nos. 12 and 22 equipped with the auxiliary ground electrodes 6 with the outside edge 622 of the inward-facing portion 62 located at substantially the same position as that of the top end 32 of the center electrode 3, as defined in the longitudinal direction of the spark plug 1. In other words, the inner end of the inward-facing portion 62 of each of the auxiliary ground electrodes 6 is oriented not to face the spark gap 11.

FIG. 9(c) illustrates the plug samples Nos. 13 and 23 having the structure of the second embodiment in which the outside edge 622 of the inner end 621 of the inward-facing portion 62 of each of the auxiliary ground electrodes 6 is located between the top end 32 of the center electrode 3 and the center electrode-facing surface 521 of the main ground electrode 5.

FIG. 9(d) illustrates the plug samples Nos. 14 and 24 having the structure of the third embodiment in which the outside edge 622 of the inner end 621 of the inward-facing portion 62 of each of the auxiliary ground electrodes 6 is located closer to the top of the spark plug 1 than the center electrode-facing surface 521 of the main ground electrode 5, and the inside edge 623 of the inner end 621 is located closer to the base of the spark plug 1 than the top end 32 of the center electrode 3.

FIG. 9(e) illustrates the plug samples Nos. 15 and 25 having the structure of the first embodiment in which the outside edge 622 of the inner end 621 of the inward-facing portion 62 of each of the auxiliary ground electrodes 6 is located closer to the top of the spark plug 1 than the center electrode-facing surface 521 of the main ground electrode 5 and the inside edge 623 of the inner end 621 is located closer to the top end of the spark plug i than the top end 32 of the center electrode 3.

FIG. 9(f) illustrates the plug samples Nos. 16 and 26 in which the outside edge 622 of the inner end 621 of the inward-facing portion 62 of each of the auxiliary ground electrodes 6 is located outside an outer surface 522 of the main ground electrode 5 which is opposite the center electrode-facing surface 521, and the inside edge 623 of the inner end 621 is located closer to the top end of the spark plug 1 than the center electrode-facing surface 521.

Dimensions of the plug samples Nos. 11 to 26 are indicated in Tables 1 and 2, as shown below.

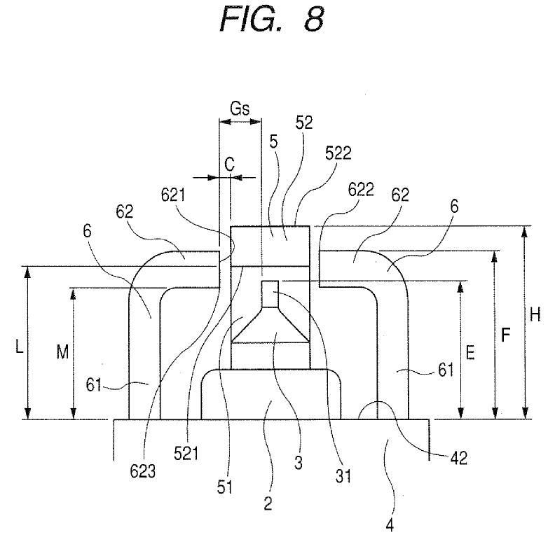

In Tables 1 and 2, “E” indicates, as can be seen from FIG. 8, the distance between the top end surface 42 of the metal shell 4 and the top end 32 of the center electrode 3, as defined in the axial direction of the spark plug 1. “F” indicates the distance between the top end surface 42 of the metal shell 4 and the outside edge 622 of the inward-facing portion 62 of the auxiliary ground electrode 6, as defined in the axial direction of the spark plug 1. “M” indicates the distance between the top end surface 42 of the metal shell 4 and the inside edge 623 of the inward-facing portion 62 of the auxiliary ground electrode 6, as defined in the axial direction of the spark plug 1. “L” indicates the distance between the top end surface 42 of the metal shell 4 and the center electrode facing surface 521 of the auxiliary ground electrode 6, as defined in the axial direction of the spark plug 1. “H” indicates the distance between the top end surface 42 of the metal shell 4 and the outer surface 522 of the main ground electrode 5, as defined in the axial direction of the spark plug 1. The same symbols, as employed in FIGS. 1, 4, and 5, indicate the same dimensions, respectively. Negative values in Tables 1 and 2 represent for cases where references of the dimensions in FIGS. 1 and 5 are reversed vertically of the spark plug 1.

TABLE 1

Sample No.

| | 11 | 12 | 13 | 14 | 15 | 16 |
|---|---|---|---|---|---|---|
| E | 3 | 3 | 3 | 3 | 3 | 3 |
| F | | 3 | 3.2 | 3.7 | 4.3 | 4.7 |
| H | 5 | 5 | 5 | 5 | 5 | 5 |
| L | 3.4 | 3.4 | 3.4 | 3.4 | 3.4 | 3.4 |
| M | | 1.9 | 2.1 | 2.6 | 3.2 | 3.6 |
| J | | −0.4 | −0.2 | 0.4 | 0.9 | 1.3 |
| A | | 1.5 | 1.3 | 0.8 | 0.2 | −0.2 |
| K | | 1.1 | 0.9 | 0.4 | −0.2 | −0.6 |
| B | | 0 | 0.2 | 0.7 | 1.3 | 1.7 |
| Gm | 0.4 | 0.4 | 0.4 | 0.4 | 0.4 | 0.4 |
| Gs | 1.75 | 1.75 | 1.75 | 1.75 | 1.75 | 1.75 |
| w1 | 2.8 | 2.8 | 2.8 | 2.8 | 2.8 | 2.8 |
| t1 | 1.6 | 1.6 | 1.6 | 1.6 | 1.6 | 1.6 |
| w2 | 2.2 | 2.2 | 2.2 | 2.2 | 2.2 | 2.2 |
| t2 | 1.1 | 1.1 | 1.1 | 1.1 | 1.1 | 1.1 |

TABLE 2

Sample No.

| | 21 | 22 | 23 | 24 | 25 | 26 |
|---|---|---|---|---|---|---|
| E | 3 | 3 | 3 | 3 | 3 | 3 |
| F | | 3 | 3.2 | 3.7 | 4.3 | 4.7 |
| H | 5.6 | 5.6 | 5.6 | 5.6 | 5.6 | 5.6 |
| L | 3.4 | 3.4 | 3.4 | 3.4 | 3.4 | 3.4 |
| M | | 1.9 | 2.1 | 2.6 | 3.2 | 3.6 |
| J | | −0.4 | −0.2 | 0.4 | 0.9 | 1.3 |
| A | | 1.5 | 1.3 | 0.8 | 0.2 | −0.2 |
| K | | 1.1 | 0.9 | 0.4 | −0.2 | −0.6 |
| B | | 0 | 0.2 | 0.7 | 1.3 | 1.7 |
| Gm | 1 | 1 | 1 | 1 | 1 | 1 |
| Gs | 1.75 | 1.75 | 1.75 | 1.75 | 1.75 | 1.75 |
| w1 | 2.8 | 2.8 | 2.8 | 2.8 | 2.8 | 2.8 |
| t1 | 1.6 | 1.6 | 1.6 | 1.6 | 1.6 | 1.6 |
| w2 | 2.2 | 2.2 | 2.2 | 2.2 | 2.2 | 2.2 |
| t2 | 1.1 | 1.1 | 1.1 | 1.1 | 1.1 | 1.1 |

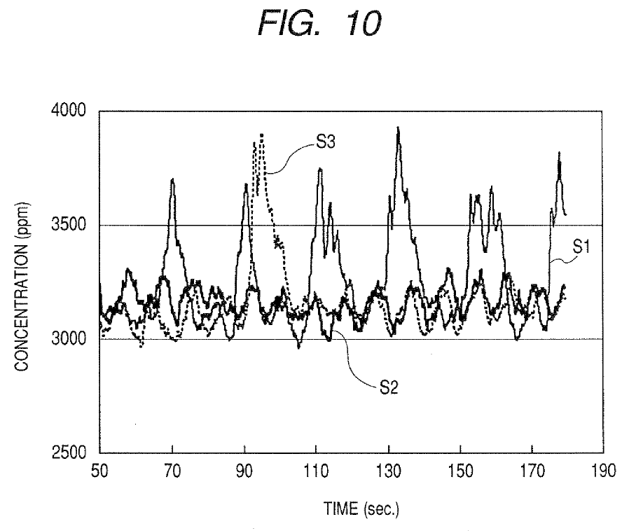

The tests were conducted by installing each of the plug samples in an internal combustion engine and measuring a temporal change in concentration of unburned gas. The engine, as used, was a single cylinder 90 cc engine and run at 9000 rpm. The ignitions timing was 10°. The measurement of the concentration of unburned gas was made using a gas analyzer HORIBA MEXA-9100. Results of the measurements are represented in a graph of FIG. 10.

The plug samples Nos. 11, 21, and 22 denote almost the same tendency of the results of measurements which are represented by a curve S1 in the graph of FIG. 10. Similarly, the plug samples Nos. 13, 23, 14, 24, 1.5, and 25 denote almost the same tendency of the results of measurements which are represented by a curve S2. The plug samples Nos. 16 and 26 denote almost the same tendency of the results of measurements which are represented by a curve S3.

The graph of FIG. 10 shows that the curve S1 represents lots of great changes in concentration of the unburned gas, the curve S3 also represents great changes in concentration of the unburned gas which are, however, smaller in frequency than the curve S1 due to the misfiring of the plug samples, and the curve S2 represents small changes in concentration of the unburned gas at low levels, which means that the plug samples 13, 23, 14, 24, 15, and 25 having the structures of the first, second, and third embodiments of the invention ensure the stability in igniting the air-fuel mixture.

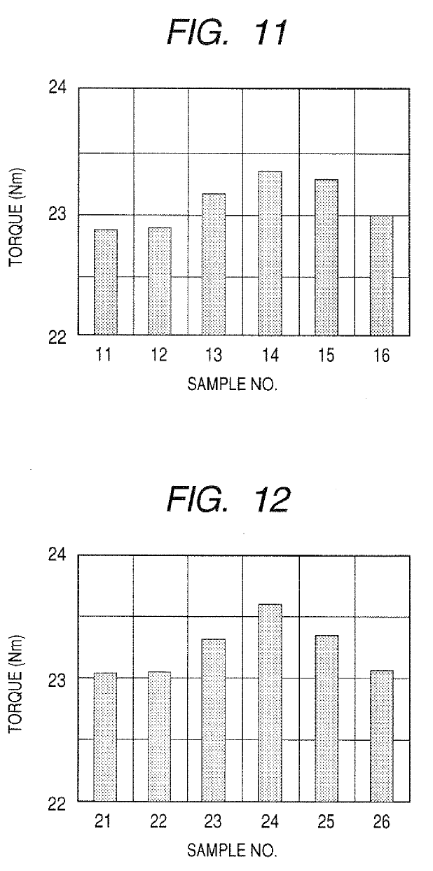

We also measured output torques produced by the internal combustion engine in which the plug samples were installed. Such measurements are presented in graphs of FIGS. 11 and 12. FIG. 11 denotes for the case where the size Gm of the spark gap 11 is 0.4 mm (i.e., the plug sample Nos. 11 to 16). FIG. 12 denotes for the case where the size Gm of the spark gap 11 is 1 mm (i.e., the plug sample Nos. 21 to 26).

The graphs of FIGS. 11 and 12 show that the plug sample Nos. 13, 14, 15, 23, 24, and 25 are higher in output torque than the other plug samples and that the plug samples having the structures of the first, second, and third embodiments of the invention ensure the stability in igniting the air-fuel mixture.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A spark plug for an internal combustion engine which has a length with a top and a base comprising:
a metal shell;
a porcelain insulator retained in said metal shell;
a center electrode installed in said porcelain insulator;
a main ground electrode including an upright portion and a center electrode-facing portion, the upright portion extending from said metal shell in a longitudinal direction of the spark plug, the center electrode-facing portion extending from the upright portion inwardly of the spark plug in a lateral direction substantially perpendicular to the longitudinal direction to have a center electrode-facing surface facing said center electrode to define a spark gap between itself and a top end of said center electrode; and
an auxiliary ground electrode including an upright portion and an inward-facing portion, the upright portion extending from said metal shell in the longitudinal direction of the spark plug, the inward-facing portion extending from the upright portion inwardly of the spark plug in the lateral direction to have an inner end facing the spark gap,
wherein the inner end of the inward-facing portion has a top edge and a base edge located outward and inward, respectively, as viewed in the longitudinal direction of the spark plug, the top edge being located one of closer to the top of the spark plug than the center electrode-facing surface of said main ground electrode and flush with the center electrode-facing surface, and
wherein a distance A between the base edge of the inner end of the inward-facing portion of said auxiliary ground electrode and the center electrode-facing surface of said main ground electrode, as defined in the longitudinal direction of the spark plug, and a distance Gm of the spark gap, as defined in the longitudinal direction of the spark plug, are selected to meet a relation of A≧Gm/3.

2. A spark plug as set forth in claim 1, wherein the base edge of the inner end of the inward-facing portion of said auxiliary ground electrode is located one of flush with the top end of said center electrode and closer to the base of the spark plug than the top end of said center electrode, and wherein a distance B between the top edge of the inner end of the inward-facing portion of said auxiliary ground electrode and the top end of said center electrode, as defined in the longitudinal direction of the spark plug, is selected to meet a relation of B≧G/3.

3. A spark plug as set forth in claim 1, wherein a minimum distance Gs (mm) between said auxiliary ground electrode and said center electrode is selected to meet a relation of Gs≧Gm+0.4 mm where a unit of Gm is mm.

4. A spark plug as set forth in claim 1, wherein a minimum distance C (mm) between said main ground electrode and said auxiliary ground electrode, as defined on a plane extending in the lateral direction of the spark plug and a minimum distance Gs (mm) between said auxiliary ground electrode and said center electrode are selected to meet a relation of 0.2 mm≦C≦Gs+0.2 mm.

5. A spark plug as set forth in claim 1, wherein the inward-facing portion of said auxiliary ground electrode is smaller in thickness and width than the center electrode-facing portion of said main ground electrode.

6. A spark plug as set forth in claim 1, wherein said center electrode is made up of a top portion and a body portion, the top portion being smaller in diameter than the body portion.

7. A spark plug for an internal combustion engine which has a length with a top and a base comprising:
a metal shell;
a porcelain insulator retained in said metal shell;
a center electrode installed in said porcelain insulator;
a main ground electrode including an upright portion and a center electrode-facing portion, the upright portion extending from said metal shell in a longitudinal direction of the spark plug, the center electrode-facing portion extending from the upright portion inwardly of the spark plug in a lateral direction substantially perpendicular to the longitudinal direction to have a center electrode-facing surface facing said center electrode to define a spark gap between itself and a top end of said center electrode; and
an auxiliary ground electrode including an upright portion and an inward-facing portion, the upright portion extending from said metal shell in the longitudinal direction of the spark plug, the inward-facing portion extending from the upright portion inwardly of the spark plug in the lateral direction to have an inner end facing the spark gap,
wherein the base edge of the inner end of the inward-facing portion of said auxiliary ground electrode is located one of flush with the top end of said center electrode and closer to the base of the spark plug than the top end of said center electrode, and
wherein a distance B between the top edge of the inner end of the inward-facing portion of said auxiliary ground electrode and the top end of said center electrode, as defined in the longitudinal direction of the spark plug, is selected to meet a relation of B≧Gm/3.

8. A spark plug as set forth in claim 7, wherein a minimum distance Gs (mm) between said auxiliary ground electrode and said center electrode is selected to meet a relation of Gs≧Gm+0.4 mm where a unit of Gm is mm.

9. A spark plug as set forth in claim 7, wherein a minimum distance C (mm) between said main ground electrode and said auxiliary ground electrode, as defined on a plane extending in the lateral direction of the spark plug and a minimum distance Gs (mm) between said auxiliary ground electrode and said center electrode are selected to meet a relation of 0.2 mm≦C≦Gs+0.2 mm.

10. A spark plug as set forth in claim 7, wherein the inward-facing portion of said auxiliary ground electrode is smaller in thickness and width than the center electrode-facing portion of said main ground electrode.

11. A spark plug as set forth in claim 7, wherein said center electrode is made up of a top portion and a body portion, the top portion being smaller in diameter than the body portion.
